(19) United States
(12) Patent Application Publication
(10) Pub. No.: US 2008/0120128 A1
(43) Pub. Date: May 22, 2008

(54) System And Method For Gathering Customer Data

(75) Inventors: Erik Berglund, Linkoping (SE); Magnus Bang, Linkoping (SE); Anders Larsson, Linkoping (SE)

Correspondence Address: VENABLE LLP, P.O. BOX 34385, WASHINGTON, DC, 20043-9998, US

(73) Assignee: OMNITUS AB, Linkoping (SE)

(21) Appl. No.: 11/795,764

(22) PCT Filed: Jan. 17, 2006
(86) PCT No.: PCT/SE06/00065

§ 371 Date: Jul. 20, 2007

(30) Foreign Application Priority Data
Jan. 20, 2005 (SE) 0500138-3

(51) Int. Cl. G06Q 10/00

(52) U.S. Cl. 705/1

(57) ABSTRACT

A system and a method for gathering customer data at a physical sales meeting premise. At least one RFID transponder is intended to be placed at the sales meeting premise. A customer data registration system includes storage for storing customer data, and element for compiling a digital material based on stored customer data, and a sender for sending the material to the customer. At least one portable unit includes an RFID reader and a communicator for communicating customer data to the customer data registration system. At least one contact input system includes an input for inputting customer data including an e-mail address and/or mobile phone number of a customer, and a communicator for communicating input customer data to the customer data registration system. Each portable unit is arranged to send customer data, which has been read from at least one RFID transponder, to the customer data registration system. The contact input system is arranged to send the e-mail address and/or mobile phone number of the customer to the customer data registration system. The customer data registration system is arranged to store customer data and compile the digital material based on stored customer data, and send the digital material to the e-mail address or mobile phone number of the customer.

### TECHNICAL FIELD

The present patent application relates to a system for gathering customer data at a physical sales meeting premise in accordance with the preamble of claim 1.

The present patent application further relates to a method for gathering customer data at a physical sales meeting premise in accordance with the preamble of claim 5.

### BACKGROUND OF THE INVENTION

During a visit at a physical shop a sales organization often wishes to gather data regarding the visiting customer for different needs. This may be both hard and soft data concerning products which the customer is interested in, about subjects of special interest to the customer, the customer's profiles and other data. In addition to data it is usually also desirable to gather the identity and contact information of the customer.

Gathering of data during a visit of a customer is in itself a difficult task. The shop environment poses high demands because new customers constantly enter and the customers do not stay for a long time. The space for a salesperson to sit down and compile data is often highly limited, possibly even non-existent. Furthermore, man to its nature is not a being having unlimited memory capacity. It is hard for us to remember more than a few things clearly and we may mix things up after a while. Further, it may be difficult to compile this kind of information during the meeting, as the sensitive relation to the customer may be disturbed. The contact with the customer must not be jeopardized and the gathering of data must be perceived as natural by the customer in order not to disturb him/her. There is often scepticism with customers to give up their contact information to a salesperson. Especially if the customer does not perceive that he/she gains something by this.

The gathering of data should be able to take place quickly, simply and without negatively affecting the relationship between the customer and the salesperson/sales-organization. An important factor is to make the customer feel that it is desirable to share his/her identity, not simply accept to share contact information but perceive it as positive to share contact information.

Today there exists limited support for gathering customer data at a physical premise. As a result thereof a majority of customer visits remain undocumented. Paper forms are used in certain cases but have no direct coupling to electronic systems and as the shop systems are being computerized the usability of paper systems for documenting decreases.

Systems which directly support gathering of customer data during customer visits in shops have up until now been based upon compilation of product codes, which have been scanned from barcodes in a shop. A previously known system for building wish lists by registering product codes is described in the patent application “INTERACTIVE IN-STORE/IN-MALL AND ONLINE SHOPPING SYSTEM AND METHOD” WO 0135186. The association between the interests of the customer and products is here done outside of the system.

The previously known system according to WO 0135186 is not able to differentiate in which shop the product code was read. Soft data, which describe the preferences of the customer, for example that the customer is interested in safety, is not handled by this and other similar systems. Furthermore, the system does not make it natural for the customer to give up his/her contact information, such that the salespersons get access thereto. The system does not have the ability to create a functioning process for gathering data, which is highly accurate in relation to the wishes of a customer.

### SUMMARY OF THE INVENTION

One object of the invention is to provide an improved system for gathering customer data at a physical sales meeting premise, through which the problems and drawbacks described above are eliminated or at least reduced.

In one embodiment of the present invention this object is achieved in accordance with the system described in claim 1.

Thanks to the provision of a system which comprises: at least one RFID transponder, intended to be placed at the physical sales meeting premise; a customer data registration system, having means for storing customer data, means for compiling a digital material based on stored customer data, and means for sending said digital material to an e-mail address or to a mobile phone number; at least one portable unit, comprising an RFID reader and means for, via a wireless computer network, communicating customer data to said customer data registration system; at least one contact input system, having means for inputting customer data, including the e-mail address and/or mobile phone number of a customer, and means for communicating input customer data to said customer data registration system; where said portable units are arranged to send customer data, read via their RFID reader from said at least one RFID transponder, to said customer data registration system, and said contact input system is arranged to, upon input thereof, send the customers e-mail address and/or mobile phone number to said customer data registration system, and that said customer data registration system is arranged to store said customer data, compile said digital material based on said stored customer data, and send said digital material to the customers e-mail address or mobile phone number, a system is created which enables gathering of customer data at a physical sales meeting premise, and which is able to differentiate at which shop data was read, and handle soft data, which describes the preferences of the customer, for example that the customer is interested in safety. The system also makes it natural for the customer to give up his/her contact information, such that a sales person/sales organization gets access thereto.

A further object of the invention is to provide an improved method for gathering customer data at a physical sales meeting premise, through which the problems and drawbacks described above are eliminated or at least reduced.

In one embodiment of the present invention this object is achieved in accordance with the method described in claim 5.

Thanks to the provision of a method which includes the steps of: placing at least one RFID transponder at the physical sales meeting premise; providing a customer data registration system, with means for storing customer data, means for compiling a digital material based on stored customer data, and means for sending the digital material to an e-mail address or a mobile phone number; providing at least one portable unit, comprising an RFID reader and means for, via a wireless computer network, communicating customer data to the customer data registration system; providing at least on contact input system, with means for inputting customer data, including an e-mail address and/or mobile phone number of a customer, and means for communicating input customer data to the customer data registration system; reading customer data from at least one RFID transponder, to each portable unit via its RFID reader; sending customer data, which has been read from at least one RFID transponder, from each portable unit to the customer data registration system; inputting the e-mail address and/or mobile phone number of the customer using the contact input system; sending the e-mail address and/or mobile phone number of the customer from the contact input system to the customer data registration system; storing these customer data in the customer data registration system's means for storing customer data; compiling the digital material based on these stored customer data; sending the digital material to the e-mail address or mobile phone number of the customer, is provided a method which enables gathering of customer data at a physical sales meeting premise, and through which it is possible to distinguish at which shop data was read, and handle soft data which describe the preferences of the customer, for example that the customer is interested in safety. The method also makes it natural for the customer to give up his/her contact information, such that a sales person/sales organisation gets access thereto.

Preferred embodiments are presented in the dependent claims.

### DESCRIPTION OF THE DRAWINGS

In the following the invention will be described in greater detail with reference to the attached drawings, in which:

FIG. 1 shows schematically a structure of the system in accordance with the pre-sent invention according to a first embodiment.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DESCRIPTION OF EMBODIMENTS

This invention relates to a system for gathering customer data at a physical sales meeting premise 2. The system enables a simple and natural process for gathering data during a visit at a premise 2, which eliminates the need for compilation after the visit and which also makes it natural for the customer to share his/her contact information. At each occasion the correct data is close at hand and the salesperson/customer does normally not have to leave the place where they stand because of the gathering of data and in that way the sales process is not disturbed. The salesperson/customer may capture rich information with very simple actions.

A further decisive ability of the system in accordance with the present invention is that it enables a functioning process for gathering customer data during customer visits to a shop 2, through the salesperson/customer making active selections of what they wish to bring along to a customer data registration system 3 and that they with their eyes see the comprised components at the shop 2.

An important factor in order to, using the system in accordance with the present invention, in a functioning manner gather customer data during a meeting at a shop 2 is that customer data may take visual physical shape at the shop, such that the sales person and the customers using their eyesight can find data. Alternative systems, which do not benefit from eyesight, do not have the same ability to function because eyesight is the most important human sense and it is known that humans are associative and that our memories and mental processes are strongly influenced or controlled by visual signals.

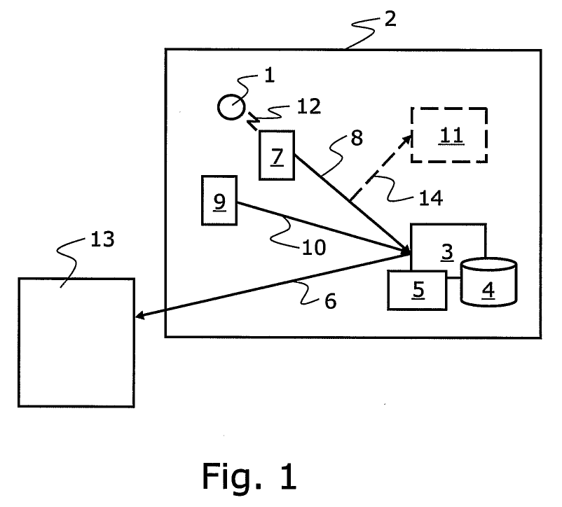

FIG. 1 illustrates schematically a structure according to the present invention of the system for gathering of customer data at a physical sales meeting premise 2 according to a first embodiment. The system comprises at least one RFID (Radio Frequency Identification) transponder 1, which is intended to be placed at the physical sales meeting premise 2. In the system is also included a customer data registration system 3, with means 4 for storing customer data, means (not shown) for compiling a digital material 5 based on stored customer data, and means (schematically illustrated by the arrow 6) for sending the digital material 5 to a communications device 13 associated with an e-mail address or a mobile phone number. Further is comprised at least one portable unit 7, comprising an RFID reader 12 and means (schematically illustrated by the arrow 8) for, via a wireless computer network, communicating customer data to the customer data registration system 3. The system has at least one contact input system 9, with means (not shown) for inputting customer data, including a customer's e-mail address and/or mobile phone number, and means (schematically illustrated by the arrow 10) for communicating input customer data to the customer data registration system 3. Each of the portable units 7 are arranged to send customer data, which via their RFID readers 12 have been read from at lest one RFID transponder 1, to the customer data registration system 3. The contact input system 9 is arranged to, following input thereof, send the customer's e-mail address and/or mobile phone number to the customer data registration system 3. The customer data registration system 3 is arranged to store these customer data, compile the digital material 5 based on these stored customer data, and send the digital material 5 to the communications device 13 associated with that customer's e-mail address or mobile phone number.

Each RFID transponder 1 may be enclosed and completely concealed inside an arbitrary physical shape, such as a plastic article, a paper, a shop display stand or a painting or a poster or be embedded in a product or a label of a product or other similar physical shape. An RFID transponder 1 is an electronic circuit having a potentially globally unique serial number, for identification, and having a readable and potentially writeable memory, for data storage. RFID transponders 1 may be read wirelessly, from varying distances, using an RFID reader, and then emit its serial number and/or data.

The RFID transponder 1 is intended to be placed at a physical sales meeting premise 2. A sales meeting premise is a place where a customer (human) meets a salesperson (human) and discusses a future business transaction, which may take place during the meeting at site, at a later time or at another location. Examples of physical sales meeting premises are shops, show-rooms, demonstration halls, exhibition stands, the entrance hall of a business, meeting rooms and to a certain extent meeting sections in offices etc. Some premises have both divisions for sales meeting premises and other divisions where sales meetings with customers do not occur.

The customer data registration system 3 has means 4 for storing customer data, which may be done in files, in databases, in documents, in another system's data storage, or in similar systems for data storage. The customer data registration system 3 also has means (not shown) for compiling a digital material 5 based on stored customer data, which may be customer data per se or a material which may be derived from customer data, where the derivation is described in a system such as a database, a document, by a computer program or a computer service. The digital material 5 may consist of digital text, audio, images and movies, documents, computer programs, web addresses, such as URLs, web services, mobile phone programs, electronic contact information, electronic business cards, electronic business proposals which may be directly practicable. Usable document formats include ASCII, Unicode, HTML (HyperText Markup Language), XML (Extensible Markup Language), PDF (Portable Document Format), PostScript, RTF (Rich Text Format), and other document formats readable by typical software, such as Microsoft® Office, Corel® WordPerfect Office, Star Office, Open Office and other similar software packages having programs for word processing, digital presentation, database and calculating programs, publication programs and other similar programs.

The customer data registration system 3 also has means 6 for sending the digital material 5 to an e-mail address or a mobile phone number. One such means 6 may be a computer system for e-mail communication, a hardware with encoded e-mail communication, or a program, a computer system for mobile phone communication, a hardware for mobile phone communication or to the customer data registration system interconnected services for communication to e-mail addresses and mobile phone numbers, which handle communication means for sending e-mail or sending data to mobile phones based on mobile phone numbers, such as SMTP (Simple Mail Transfer Protocol), SMS (Short Message Service), MMS (Multimedia Messaging Service). Communication means 6 for sending the digital material 5 to an e-mail address or mobile phone number may also include sending the digital material 5 to a program arranged such that the program in turn sends the digital material 5. The customer data registration system 3 may be pre-sent in the portable units 7 having RFID readers 12, at its own location in the computer network or as part of another system, such as a business software.

The portable unit 7 with an RFID reader may be a mobile phone having an integrated RFID reader, a handheld computer having an integrated RFID reader, a handheld wireless RFID reader, which sends its signal directly to the computer network, a portable slave-screen or terminal-computer having a physically attached or an integrated RFID reader, and a wireless computer network or other similar hardware. The wireless computer network may be a radio network, such as a WLAN (Wireless Local Area Network), a Bluetooth network (Bluetooth®), a mobile phone network, such as GSM (Global System for Mobile Communications), GPRS (General Packet Radio Service), 3G (Third Generation), sound and light networks, such as IR (Infra Red) based networks, e.g. according to the IrDA® (Infrared Data Association) standard, and other similar networks for data communication. The computer network may be local at the sales meeting premise 2, connected to the Intranet of an organization, or to the Internet.

The contact input system 9 has means which enable humans to input e-mail addresses or mobile phone numbers, such as keyboards, touch screens or similar input systems. The contact input system 9 also has means 10 for communicating input e-mail addresses or mobile phone numbers to the customer data registration system 3 via a computer network, which may be a wireless or wired computer network, such as WLAN (Wireless Local Area Network), LAN (Local Area Network), WAN (Wide Area Network), a Bluetooth network (Bluetooth®), IR (Infra Red) based networks, e.g. according to the IrDA® (Infrared Data Association) standard, serial or parallel port, USB (Universal Serial Bus), portable data memory, Firewire (IEEE-1394). The contact input system 9 may be present in the portable unit 7 having RFID reader 12 or as a separate system at the physical sales meeting premise 2, in a handheld or stationary computer or an information kiosk having means for input, or another built in computer system, or similar input system, or be transferred from a unit brought by the customer, such as a mobile phone, a handheld computer, a portable memory, a laptop computer or other technology for storing and electronically transferring contact information as e-mail and/or mobile phone numbers.

The portable units 7 having RFID readers 12 are arranged to send customer data, which via their RFID readers 12 have been read from at least one RFID transponder 1, to the customer data registration system 3. The contact input system 9 is arranged to, upon input thereof, send the customers e-mail address and/or mobile phone number to the customer data registration system 3. The customer data registration system 3 is arranged to store these customer data, compile the digital material 5 based on these stored customer data, and send the digital material 5 to a communications device 13 associated with the e-mail address or mobile phone number of the customer. Each portable unit 7 having an RFID reader 12 is brought into proximity of at least one RFID transponder 1, reads customer data from the RFID transponder 1 and sends read customer data to the customer data registration system 3. Data read from the RFID trans-ponders 1 may be the serial number of the respective RFID transponders or data read into a memory of each RFID transponder 1.

In an additional embodiment the inventive system includes multimedia units 11, which are intended to be placed at the physical sales meeting premise 2. The multimedia units 11 comprises means (schematically illustrated by the arrow 14) for receiving, via the wireless computer network, wirelessly communicated customer data and means (not shown) for presenting multimedia based on these customer data.

Multimedia units 11 are units which are able to display digital media, such as text, images, sounds and movies. Examples of multimedia units 11 is a computer having connected touch screens, a large size screen, a projector, a Plasma TV device, an LCD screen, or other similar unit, and portable computers having screens, such as a laptop computer, a TabletPC device, a handheld computer, a mobile phone, or other similar portable unit or a computer having a portable slave-screen or other similar unit and units for audio reproduction, such as loudspeakers.

The multimedia unit 11 has means 12 for controlling its multimedia presentation, based on these customer data, via presentation systems, such as Microsoft® PowerPoint®, Macromedia® Flash® player, web browser systems such as Microsoft® Internet Explorer®, Mozilla®, or Adobe® Acrobat® or other similar presentation systems.

The multimedia unit 11 further has means 14 for receiving customer data, which have been read from the RFID transponders 1 and sent with the means 8 for communicating on wireless computer networks by the portable unit 7 with RFID reader 12. Means 14 for receiving customer data are provided through the multimedia unit 11 having means for monitoring data communications sent with the means 8 for communicating via wireless computer networks or through that the customer data registration system 3 and/or the portable units 7 with RFID readers 12 are arranged such that they also send read customer data to the multimedia units 11.

In yet another embodiment of the system at least one portable unit 7, having an RFID reader 12 and means 8 for, via a wireless computer network, communicating customer data to the customer registration system 3, is a mobile phone, a handheld computer or a portable display equipped computer having a physically connected or integrated RFID reader 12.

In yet another embodiment of the system the customer data registration system 3 is part of a business software, in which the gathering of customer data may be a means for compiling quotations or business proposals.

In a first usage example a customer arrives at a shop 2 and is met there by a salesperson. The customer and the salesperson walk around the shop 2 together. Together they walk up to a poster, which is posted and, which presents the different needs that the products of the shop cater for. Together they agree that the customer is interested in safety, cost, loading capacity and has pets. The sales person registers this by sweeping a handheld computer 7 over different parts 1 of the poster and thus captures important data about the customer. It becomes a natural part of agreeing what is relevant for the customer and the sales person point at these factors in order to emphasize their common understanding, which at the same time leads to registration of data regarding the interests of the customer.

The customer and the sales person look at many different products at the shop 2 and at different occasions the salesperson sweeps his/her handheld computer 7 across certain products in order to register them. As the customer then is about to go home and consider, the sales person ask for permission to send along with the customer a personal material in order for the customer to see what they have covered during the meeting. The customer desires the material and gives the salesperson his/her e-mail address, in order to be able to receive the electronic material.

In a second usage example a customer arrives at a shop 2 and makes an own walk around. Using his/her mobile phone 7, which is equipped to read physical identifiers 1, the customer chooses certain physical identifiers 1, which are placed at different locations at the shop 2. The customer then leaves the shop 2 and after a while receives a message, which offers a material sent to his/her mobile phone 7 via the phone network. A set of hyperlinks, taking the customer to material on the network, is presented by the mobile phone 7 and may be activated directly or transferred to a computer and activated there from.

The present invention also relates to a method for gathering of customer data at a physical sales meeting premise 2. The method comprises the steps of: placing at least one RFID transponder 1 at the physical sales meeting premise 2; providing a customer data registration system 3, with means 4 for storing customer data, means for compiling a digital material 5 based on stored customer data, and means 6 for sending the digital material 5 to an e-mail address or a mobile phone number; providing at least one portable unit 7, comprising an RFID reader 12 and means 8 for, via a wireless computer network, communicating customer data to the customer data registration system 3; providing at least one contact input system 9, with means for inputting customer data, comprising an e-mail address and/or mobile phone number of a customer, and means 10 for communicating input customer data to the customer data registration system 3; reading customer data from the at least one RFID transponder 1, to each portable unit 7 via its RFID reader 12; sending customer data, which has been read from the at least one RFID transponder 1, from each portable unit 7 to the customer data registration system 3; inputting the e-mail address and/or mobile phone number of the customer using the contact input system 9; sending the e-mail address and/or mobile phone number of the customer from the contact input system 9 to the customer data registration system 3; storing these customer data in the customer data registration system's 3 means 4 for storing customer data; compiling the digital material 5 based on the stored customer data; sending the digital material 5 to the e-mail address or mobile phone number 10 of the customer.

In a further embodiment the method includes the steps of: placing multimedia units 11 at the physical sales meeting premise 2, which multimedia units 11 comprises means 14 for receiving via a wireless computer network communicated customer data and means for presenting multimedia based on these customer data.

The invention is not limited to the above-described embodiments, but may be varied within the scope of the following claims.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A system for gathering customer data during a visit at a physical sales meeting premise, the system comprising:
at least one RFID transponder intended to be placed at the physical sales meeting premise;
a customer data registration system having means for storing customer data, means for compiling a digital material based on stored customer data during the visit at the physical sales meeting premise, and means for sending said digital material to an email address or to a mobile phone number;
at least one portable unit comprising an RFID reader and means for communicating customer data to said customer data registration system via a wireless computer network; and
at least one contact input system having means for, during the visit at the physical sales meeting premise, inputting customer data including the e-mail address and/or mobile phone number of a customer, and means for communicating input customer data to said customer data registration system;
wherein said portable units are arranged to send customer data, read via their RFID reader during the visit at the physical sales meeting premise, from said at least one RFID transponder, to said customer data registration system, and said contact input system is arranged to, upon input thereof, send the customers e-mail address and/or mobile phone number to said customer data registration system, and wherein said customer data registration system is arranged to store said customer data, compile said digital material based on said stored customer data, and send said digital material to the customers, during the visit at the physical sales meeting premise, input e-mail address or mobile phone number.

2. The system according to claim 1, further comprising:
multimedia units intended to be placed at said physical sales meeting premise, which multimedia units comprise means for receiving said via a wireless computer network communicated customer data and means for presenting multimedia based on said customer data.

3. The system according to claim 1, wherein said at least one portable unit with RFID reader and means for, via a wireless computer network, communicating customer data to said customer data registration system is a mobile phone, a handheld computer or a laptop computer having a physically connected or an integrated RFID reader.

4. The system according to claim 1, wherein said customer data registration system is part of a business software.

5. A method for gathering of customer data during a visit at a physical sales meeting premise, the method comprising:
placing at least one RFID transponder at the physical sales meeting premise;
providing a customer data registration system comprising means for storing customer data, means for compiling a digital material based on stored customer data during the visit at the physical sales meeting premise, and means for sending said digital material to an e-mail address or a mobile phone number;
providing at least one portable unit, comprising an RFID reader and means for communicating customer data to said customer data registration system via a wireless computer network;
providing at least one contact input system comprising means for, during the visit at the physical sales meeting premise, inputting customer data comprising an e-mail address and/or mobile phone number of a customer, and means for communicating input customer data to said customer data registration system; and
during the visit at the physical sales meeting premise:
reading customer data from said at least one RFID transponder, to said portable units via their RFID readers;
sending customer data, which has been read from said at least one RFID transponder, from said portable units to said customer data registration system;
inputting the e-mail address and/or mobile phone number of the customer using said contact input system;
sending the e-mail address and/or mobile phone number of the customer from said contact input system to said customer data registration system;
storing said customer data in said customer data registration system's means for storing customer data;
compiling said digital material based on said stored customer data; and
sending said digital material to the e-mail address or mobile phone number of the customer.

6. The method according to claim 5, further comprising:
placing multimedia units at said physical sales meeting premise, which multimedia units comprise means for receiving said via a wireless computer network communicated customer data and means for presenting multimedia based on said customer data.
